(19) United States
(12) Patent Application Publication
(10) Pub. No.: US 2024/0119565 A1
(43) Pub. Date: Apr. 11, 2024

(54) IMAGE PROCESSING DEVICE, IMAGE PROCESSING METHOD, AND PROGRAM

(71) Applicant: SONY GROUP CORPORATION, TOKYO (JP)

(72) Inventors: NOBUHIRO TSUNASHIMA, TOKYO (JP); DAISUKE TAHARA, TOKYO (JP)

(21) Appl. No.: 18/257,578

(22) PCT Filed: Nov. 19, 2021
(86) PCT No.: PCT/JP2021/042589

§ 371 Date: Jun. 14, 2023

(30) Foreign Application Priority Data
Dec. 22, 2020 (JP) 2020-212635

(51) Int. Cl. G06T 5/50; G06T 3/40; G06V 10/25

(52) U.S. Cl. CPC G06T 5/50; G06T 3/40; G06V 10/25; G06T 2207/20132; G06T 2207/20221; G06V 2201/07

(57) ABSTRACT

An image processing device includes an image clipping unit that sets a clipping region for a target subject detected in input image data according to an image size of a specific portion related to the target subject, and performs clipping processing.

### TECHNICAL FIELD

The present technology relates to an image processing device, an image processing method, and a program, and particularly relates to a technology of displaying an image suitable for focus operation of a captured image.

### BACKGROUND ART

When an image is captured by an imaging device such as a still camera or a video camera, an object having a different distance from the camera such as a background may be blurred by focusing on an imaging target. This is because there is an effect of making the imaging target stand out by blurring the background and focusing only on the imaging target.

Methods for focusing are roughly divided into two. The two are manual focusing in which a target subject is focused by an operation of a person (hereinafter, referred to as a user) who operates the camera, and autofocus in which the camera automatically focuses.

In autofocus, the camera automatically performs a focusing operation, but on the other hand, a target desired by a user is not always in focus. Thus, at the time of movie shooting or imaging of image content such as a television broadcast program, manual focus in which the user manually focuses is often used.

Patent Document 1 below discloses a technique for displaying an index based on a focus state for manual focus operation.

### CITATION LIST

### Patent Document

Patent Document 1: Japanese Patent Application Laid-Open No. 2016-197179

### SUMMARY OF THE INVENTION

### Problems to be Solved by the Invention

Incidentally, in a case where the user performs manual focus operation with visual checking while capturing an image with the camera, it is necessary to provide an image display device on a camera main body or around the camera main body. A person who operates the camera performs an operation of focusing while looking at a desired target in an image displayed on the display device.

In recent years, the resolution of an image captured by a camera has been refined. The standard of resolution of images of current television broadcasting is mainly 2K (1920×1080 pixels), but broadcasting of 4K (3840×2160 pixels) has started, and imaging of 8K (7680×4320 pixels) has also started.

In contrast, a problem is the resolution of the display device in the camera main body or around the camera main body. As the display device for visual recognition by the user when focusing the camera, in many cases, a large display device cannot be installed, and only a small display device is used due to space issues. Furthermore, even if the display resolution of the small display device mounted on the camera is forcibly increased, it is difficult for human eyes to visually recognize an image in fine details.

For this reason, actually, the display device set in the camera main body or the periphery thereof is often 2K (1920×1080 pixels) or half HD (960×540 pixels) which is half of 2K, or the like. Then, in a case where an image of 4K or more is captured, the resolutions of the image and the display device do not match, and thus the image captured by the camera is reduced in size and displayed on the display device. When the captured image is reduced in size, a detailed portion of the image is collapsed, and consequently, it is difficult to correctly perform focusing.

Accordingly, the present disclosure proposes an image processing technology that enables monitoring of a captured image in a state suitable for manual focus operation.

### Solutions to Problems

An image processing device according to the present technology includes an image clipping unit that sets a clipping region for a target subject detected in input image data according to an image size of a specific portion related to the target subject, and performs clipping processing.

For example, a subject that can be a focus target is set as a target subject of a display possibility of a clipped image. By clipping an image of the target subject, the target subject can be displayed for assisting a focus operation of the user. In this case, the clipping region is set according to the size of the specific portion related to the target subject in an input image. The specific portion related to the target subject is only required to be determined by the type of the target subject.

In the image processing device according to the present technology described above, it is conceivable that the image clipping unit sets a center position of the clipping region according to the image size of the specific portion related to the target subject.

For example, by setting coordinate values as the center position of the clipping region, a clipping range in which the target subject is appropriately arranged in the clipped image is determined.

It is conceivable that the image processing device according to the present technology described above further includes an image combining unit that combines through image data obtained by reducing a resolution of the input image data and clipped image data generated by the clipping processing.

For example, the through image data and the clipped image data are combined in such a manner that a through image obtained by reducing the resolution of a captured image and the clipped image are displayed in one screen.

In the image processing device according to the present technology described above, it is conceivable that the image clipping unit performs the clipping processing from image data having a resolution higher than that of through image data obtained by reducing the resolution of the input image data.

For example, a clipping region corresponding to an image size is set for the input image data, and the clipping processing is performed. Alternatively, it is also assumed that clipping is performed from image data obtained by performing enlargement processing on the input image data. Moreover, it is also assumed that clipping is performed from image data obtained by reducing the input image data but having a resolution higher than that of the through image data.

In the image processing device according to the present technology described above, it is conceivable that the image clipping unit performs the clipping processing from the input image data.

Clipping is performed from the input image data itself having a high resolution.

In the image processing device according to the present technology described above, it is conceivable that the image combining unit combines the through image data and the clipped image data in such a manner that a clipped image is superimposed on a through image.

For example, a superimposed region is provided on the through image so that the clipped image is displayed.

In the image processing device according to the present technology described above, it is conceivable that the image combining unit combines the through image data and the clipped image data in such a manner that a clipped image is superimposed near a corresponding target subject on a through image.

For example, on the through image, a superimposed region of the clipped image is set near the corresponding subject displayed on the clipped image, and which part of the through image the clipped image corresponds to is made easy to understand.

In the image processing device according to the present technology described above, it is conceivable that the image combining unit combines the through image data and the clipped image data in such a manner that a display region of a clipped image and a display region of a through image are divided on one screen.

For example, after the entire through image is displayed on the screen, the clipped image is displayed in another region.

In the image processing device according to the present technology described above, it is conceivable to include an image recognition unit that performs subject recognition processing on the input image data and detects a target subject as a display possibility of a clipped image, in which the image clipping unit performs the clipping processing on a selected target subject among target subjects detected by the image recognition unit.

The image recognition unit can detect a plurality of target subjects (for example, key points used for focus assist) by performing the subject recognition processing. Not all of them are set as targets of the clipping processing, but the target subject is selectively set as a target of the clipping processing.

In the image processing device according to the present technology described above, it is conceivable that the image clipping unit performs the clipping processing on a target subject selected on the basis of a priority order set for each type of target subjects among the target subjects detected by the image recognition unit.

The priority order is determined for target subjects as key points to be used for the focus assist, and the target of the clipping processing is selectively determined from the detected target subjects.

In the image processing device according to the present technology described above, it is conceivable that the image clipping unit performs the clipping processing on a target subject selected by an operation among the target subjects detected by the image recognition unit.

The user is allowed to perform a selection operation on the detected target subjects, and a target subject selected by the operation is set as the target of the clipping processing.

In the image processing device according to the present technology described above, it is conceivable that the image combining unit combines the through image data on which peaking processing indicating an in-focus determination portion has been performed and the clipped image data on which the peaking processing has not been performed.

That is, it is assumed that peaking display is performed on the through image on the screen, but peaking display is not performed on the clipped image.

In the image processing device according to the present technology described above, it is conceivable that the peaking processing is processing of performing peaking display only in a region indicating the target subject in the through image data.

For the through image, peaking display is performed only in a region of the target subject, for example, in a frame indicating the target subject.

In the image processing device according to the present technology described above, it is conceivable that the image clipping unit performs the clipping processing of a region other than the target subject detected by the image recognition unit.

For example, even when the target subject is not detected, the clipping region is set and clipping is performed.

In the image processing device according to the present technology described above, it is conceivable that the image clipping unit performs the clipping processing on one or more fixed regions on an image to display a clipped image of the one or more fixed regions, and in a case where the image clipping unit performs the clipping processing on the target subject, a clipped image of the target subject is displayed instead of the clipped image of the fixed region close to a position of the target subject.

When the target subject is detected while the clipped image of the fixed region on the screen is displayed, the clipped image of the fixed region is replaced with the clipped image of the target subject.

In the image processing device according to the present technology described above, it is conceivable that the image recognition unit performs the subject recognition processing using image data obtained by reducing a resolution of the input image data.

For example, the subject recognition processing is performed after the resolution of the input image data having the high resolution is reduced instead of the input image data having the high resolution as it is.

An image processing method according to the present technology is an image processing method including setting a clipping region for a target subject detected in input image data according to an image size of a specific portion related to the target subject, and performing clipping processing.

Thus, the clipping region is appropriately set.

A program according to the present technology described above is a program for causing an arithmetic processing device to execute the above processing.

Thus, it is possible to easily achieve the image processing device of the present technology.

### BRIEF DESCRIPTION OF DRAWINGS

FIG. 1 is a perspective view of an imaging device on which an image processing device of an embodiment of the present technology can be mounted.

FIG. 2 is a rear view of the imaging device on which the image processing device of the embodiment can be mounted.

FIG. 3 is a block diagram of the imaging device on which the image processing device of the embodiment can be mounted.

FIG. 4 is an explanatory diagram of various mounting modes of the image processing device of the embodiment.

FIG. 5 is a block diagram of the image processing device of the embodiment.

FIG. 6 is an explanatory diagram of a display state of a comparative example.

FIG. 7 is an explanatory diagram of a display state of the embodiment.

FIG. 8 is a flowchart of a processing example of a first embodiment and a second embodiment.

FIG. 9 is a flowchart of an example of clipping processing of the embodiment.

FIG. 10 is an explanatory diagram of another display mode of a clipped image of the embodiment.

FIG. 11 is an explanatory diagram of still another display mode of the clipped image of the embodiment.

FIG. 12 is an explanatory diagram of the display mode by a user operation of a third embodiment.

FIG. 13 is a flowchart of a processing example of the third embodiment.

FIG. 14 is an explanatory diagram of a display mode of a fifth embodiment.

FIG. 15 is an explanatory diagram of the display mode of the fifth embodiment.

FIG. 16 is an explanatory diagram of a display mode of a sixth embodiment.

FIG. 17 is a block diagram of an image processing device of the sixth embodiment.

FIG. 18 is a block diagram of an image processing device of a seventh embodiment.

### MODE FOR CARRYING OUT THE INVENTION

Hereinafter, embodiments will be described in the following order.
<1. Mounting mode of image processing device>
<2. First Embodiment>
<3. Second Embodiment>
<4. Third Embodiment>
<5. Fourth Embodiment>
<6. Fifth Embodiment>
<7. Sixth Embodiment>
<8. Seventh Embodiment>
<9. Summary and modification example>

Here, meanings of some terms used in the present disclosure will be described.

An “image” is used as a term including both “still image” and “moving image”.

A “through image” is an image displayed for the imaging person to monitor the subject side. In a device or a system that captures an image, an image (moving image) on the subject side is monitored and displayed for capturing a still image, and monitoring display is also performed while capturing a moving image or during standby of capturing a moving image. In the present disclosure, these are collectively referred to as a through image.

A “clipped image” is, for example, an image that is partially clipped and displayed for use in focus assist, or the like.

The “through image” and the “clipped image” refer to an image displayed on a display device, and “through image data” and “clipped image data” refer to image data for executing display of the through image and the clipped image.

A “key point” is a term indicating a subject detected as a possibility for a focus target by subject recognition processing, and is used in the meaning of a “target subject” in the present technology. In the embodiment, an example in which a person, an object, or a part (for example, a face, an eye (pupil), an ear, and the like) of a person or an object as a subject is detected as a key point will be described.

### 1. MOUNTING MODE OF IMAGE PROCESSING DEVICE

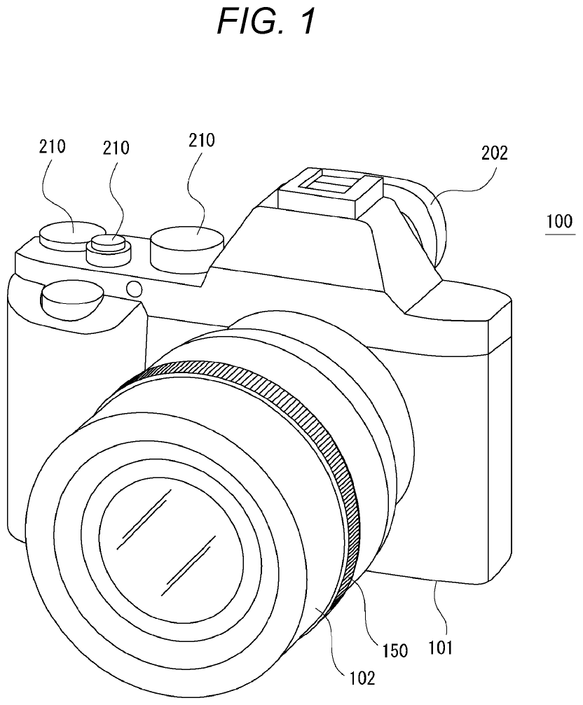

The image processing device 1 of the embodiment performs image processing suitable for display to assist the focus operation of the user, and various mounting modes are assumed for the image processing device 1. First, as an example, a configuration example in a case where the image processing device 1 of the embodiment is mounted on an imaging device 100 will be described with reference to FIGS. 1 to 3.

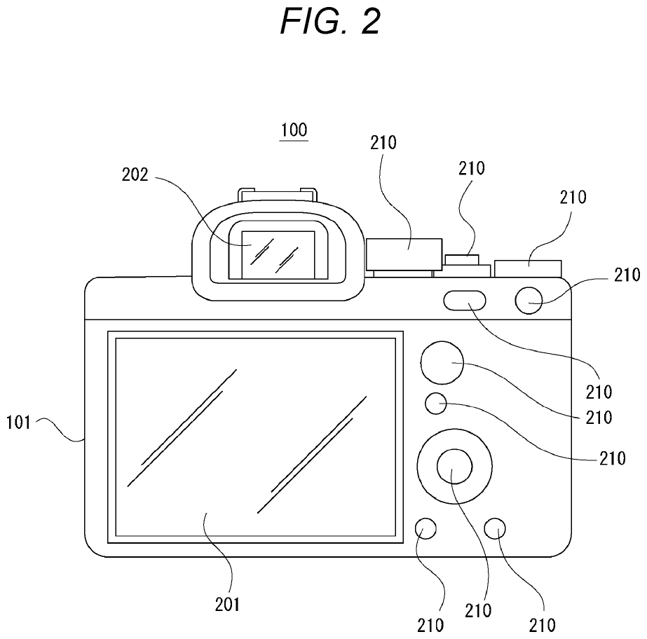

FIG. 1 is a front perspective view of the imaging device 100, and FIG. 2 is a rear view thereof. In this example, the imaging device 100 is what is called a digital still camera, and by switching an imaging mode, both imaging of a still image and imaging of a moving image can be performed.

Note that, in the present embodiment, the imaging device 100 is not limited to the digital still camera, and may be a video camera mainly used for capturing a moving image, a camera capable of capturing only a still image, or a camera capable of capturing only a moving image. Of course, a camera for business use that is used in a broadcasting station or the like may be used.

In the imaging device 100, a lens barrel 102 is disposed on the front side of a main body housing 101 constituting the camera main body.

In a case where the camera is configured as what is called an interchangeable lens camera, the lens barrel 102 is detachable from the main body housing 101, and lenses can be exchanged.

In addition, the lens barrel 102 may not be detachable from the main body housing 101. For example, there are a configuration example in which the lens barrel 102 is fixed to the main body housing 101, and a configuration example as a retractable type that transitions between a state where the lens barrel 102 is retracted and stored on the front surface of the main body housing 101 and a state where the lens barrel 102 protrudes and becomes usable.

The configuration of the imaging device 100 may be any of the above configurations, but the lens barrel 102 is provided with a ring 150 for manual focus operation, for example.

As illustrated in FIG. 2, on a back side (user side) of the imaging device 100, for example, a display panel 201 including a display device such as a liquid crystal display (LCD) or an organic electro-luminescence (EL) display is provided.

In addition, a display unit formed using an LCD, an organic EL display, or the like is also provided as a view finder 202. The view finder 202 is, for example, an electronic view finder (EVF). However, an optical view finder (OVF) may be used, or a hybrid view finder (HVF) using a transmissive liquid crystal may be used.

The user can visually recognize an image and various types of information by the display panel 201 and the view finder 202.

In this example, the imaging device 100 is provided with both the display panel 201 and the view finder 202 but is not limited thereto, and may be provided with only one of the display panel 201 and the view finder 202, or with both or one of the display panel 201 and the view finder 202 being detachable.

Various controls 210 are provided on the main body housing 101 of the imaging device 100.

For example, as the controls 210, various forms such as a key, a dial, and a combined press-rotation control are provided to achieve various operation functions. For example, a shutter operation, a menu operation, a reproduction operation, a mode selection operation, a focus operation, a zoom operation, a selection operation of parameters such as a shutter speed and an F value, and the like can be performed.

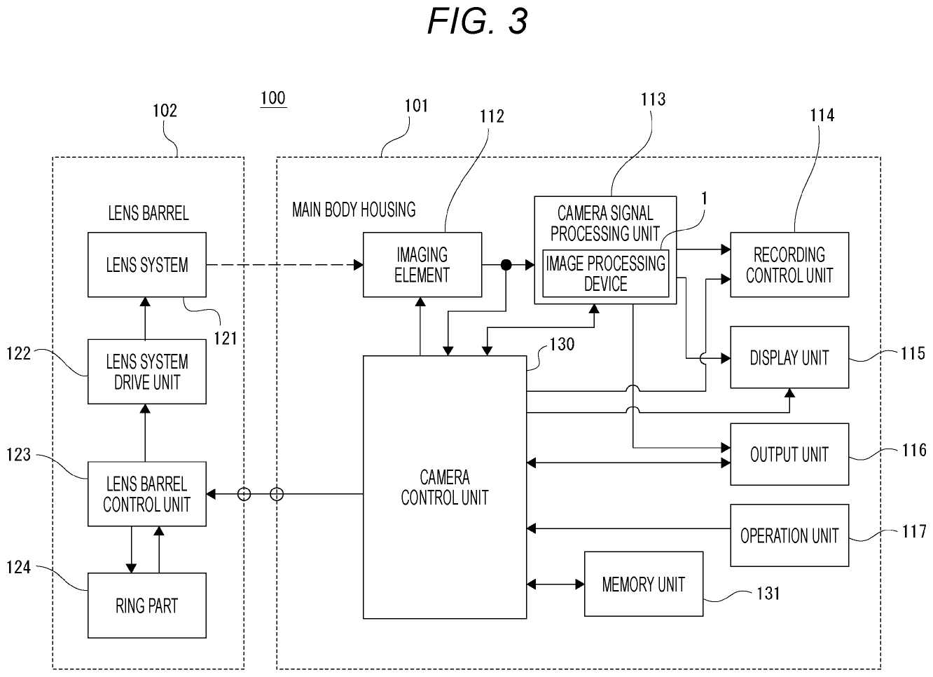

FIG. 3 illustrates an internal configuration of the imaging device 100 including the lens barrel 102. Note that FIG. 3 illustrates an example in which the imaging device 100 is divided into the main body housing 101 and the lens barrel 102.

The imaging device 100 includes an imaging element (image sensor) 112, a camera signal processing unit 113, a recording control unit 114, a display unit 115, an output unit 116, an operation unit 117, a camera control unit 130, and a memory unit 131 in the main body housing 101.

Furthermore, the lens barrel 102 includes a lens system 121, a lens system drive unit 122, a lens barrel control unit 123, and a ring part 124.

The lens system 121 in the lens barrel 102 includes lenses such as a zoom lens and a focus lens, and an iris (diaphragm mechanism). Light (incident light) from a subject is guided by the lens system 121 and condensed on the imaging element 112.

The imaging element 112 is configured as, for example, a charge coupled device (CCD) type, a complementary metal oxide semiconductor (CMOS) type, or the like.

The imaging element 112 executes, for example, correlated double sampling (CDS) processing, automatic gain control (AGC) processing, or the like on an electrical signal obtained by photoelectrically converting received light, and further performs analog/digital (A/D) conversion processing. Then, an imaging signal as digital data is output to the camera signal processing unit 113 and the camera control unit 130 in a subsequent stage.

The camera signal processing unit 113 is configured as an image processing processor by, for example, a digital signal processor (DSP) or the like. The camera signal processing unit 113 performs various types of signal processing on a digital signal (captured image signal) from the imaging element 112. For example, as a camera process, the camera signal processing unit 113 performs preprocessing, simultaneous processing, YC generation processing, resolution conversion processing, codec processing, and the like.

Here, the camera signal processing unit 113 has a function as the image processing device 1. Here, the image processing device 1 refers to a processing function of generating a through image, generating a clipped image for focus assist, combining the through image and the clipped image, and the like.

The configuration and operation of the image processing device 1 will be described later.

The recording control unit 114 performs recording and reproduction on a recording medium by a non-volatile memory, for example. The recording control unit 114 performs processing of recording an image file such as moving image data and still image data, a thumbnail image, or the like on a recording medium, for example.

Various actual forms of the recording control unit 114 can be considered. For example, the recording control unit 114 may be configured as a flash memory built in the imaging device 100 and a write-read circuit thereof, or may be in the form of a card recording-reproducing unit that performs recording-reproducing access to a recording medium that can be attached to and detached from the imaging device 100, for example, a memory card (portable flash memory or the like). Furthermore, it may be implemented as a hard disk drive (HDD) or the like as a form built in the imaging device 100.

The display unit 115 is a display unit that displays various displays to the imaging person, and specifically indicates the display panel 201 and the view finder 202 illustrated in FIG. 2.

The display unit 115 executes various displays on the display screen on the basis of an instruction from the camera control unit 130. For example, the display unit 115 displays a reproduced image of image data read from the recording medium in the recording control unit 114. Furthermore, the image data of the captured image whose resolution has been converted for display by the camera signal processing unit 113 is supplied to the display unit 115, and the display unit 115 performs display on the basis of the image data of the captured image in response to an instruction from the camera control unit 130. That is, through image display is performed.

Furthermore, the display unit 115 causes display of various operation menus, icons, messages, and the like, that is, display as a graphical user interface (GUI) to be executed on the screen on the basis of instructions of the camera control unit 130.

The output unit 116 performs data communication and network communication with an external device by wire or wirelessly. For example, captured image data (still image file or moving image file) is transmitted and output to an external display device, recording device, reproduction device, information processing device, or the like.

Furthermore, assuming that it is a network communication unit, for example, the output unit 116 may communicate with various networks such as the Internet, a home network, and a local area network (LAN), and transmit and receive various data to and from a server, a terminal, and the like on the network.

The operation unit 117 collectively indicates input devices for the user to perform various operation inputs. Specifically, the operation unit 117 indicates the various controls 210 provided in the main body housing 101. The operation unit 117 detects an operation by the user, and a signal corresponding to the input operation is sent to the camera control unit 130.

As the operation unit 117, not only the controls 210 but also a touch panel may be used. For example, a touch panel may be formed on the display panel 201, and various operations may be possible by operating the touch panel using icons, menus, and the like to be displayed on the display panel 201.

Alternatively, the operation unit 117 may also have a mode of detecting a tap operation or the like by the user with a touch pad or the like.

Moreover, the operation unit 117 may be configured as a reception unit of an external operation device such as a separate remote controller.

The camera control unit 130 includes a microcomputer (arithmetic processing device) equipped with a central processing unit (CPU).

The memory unit 131 stores information and the like used for processing by the camera control unit 130. The illustrated memory unit 131 comprehensively indicate, for example, a read only memory (ROM), a random access memory (RAM), a flash memory, and the like.

The memory unit 131 may be a memory area built in a microcomputer chip as the camera control unit 130 or may be configured by a separate memory chip.

The camera control unit 130 controls the entire imaging device 100 and the lens barrel 102 by executing a program stored in the ROM of the memory unit 131, the flash memory, or the like.

For example, the camera control unit 130 controls operation of each necessary part for controlling shutter speed of the imaging element 112, instructing various signal processing in the camera signal processing unit 113, imaging operation and recording operation according to an operation by the user, reproduction operation of a recorded image file, operation of a user interface, and the like. For the lens system 121, the camera control unit 130 performs, for example, autofocus control of automatically focusing on a target subject, change of an F value according to a setting operation of the user, automatic iris control of automatically controlling the F value, and the like.

The RAM in the memory unit 131 is used for temporarily storing data, programs, and the like as a work area for various data processing of the CPU of the camera control unit 130.

The ROM and the flash memory (non-volatile memory) in the memory unit 131 are used for storing an operating system (OS) for the CPU to control each unit, content files such as image files, application programs for various operations, and firmware, and the like.

When the lens barrel 102 is attached to the main body housing 101, the camera control unit 130 communicates with the lens barrel control unit 123 and gives various instructions.

The lens barrel 102 is equipped with, for example, the lens barrel control unit 123 with a microcomputer, and various data communication with the camera control unit 130 is possible. For example, the camera control unit 130 instructs the lens barrel control unit 123 to drive a zoom lens, a focus lens, an iris (diaphragm mechanism), and the like. The lens barrel control unit 123 controls the lens system drive unit 122 in response to these drive instructions to execute the operation of the lens system 121.

The lens system drive unit 122 is provided with, for example, a motor driver for a zoom lens drive motor, a motor driver for a focus lens drive motor, a motor driver for an iris, and the like.

In these motor drivers, a drive current is applied to the corresponding driver in response to an instruction from the lens barrel control unit 123 to perform moving the focus lens and zoom lens, opening and closing diaphragm blades of the iris, and the like.

The ring part 124 includes the ring 150 illustrated in FIG. 1, a rotation mechanism of the ring 150, a sensor for detecting a rotation angle of the ring 150, and the like. In response to detecting the rotation of the ring 150 in the ring part 124, the lens barrel control unit 123 outputs a drive instruction to the lens system drive unit 122 to drive the focus lens.

Note that the above is merely an example of the configuration of the imaging device 100.

Although the image processing device 1 of the embodiment is included in the camera signal processing unit 113 as an example, the image processing device 1 may be configured by software in the camera control unit 130, for example. Furthermore, the image processing device 1 may be configured by a chip or the like separate from the camera signal processing unit 113 and the camera control unit 130.

Furthermore, the imaging device 100 described above includes the image processing device 1 and the display unit 115 including the display panel 201 and the view finder 202, and displays a through image. In addition, the image processing device 1 performs processing of displaying a clipped image for focus assist together with the through image. Accordingly, the imaging device 100 is configured to display the through image and the clipped image on the display unit 115 on the basis of the processing of the image processing device 1.

However, it is also assumed that a through image or a clipped image is displayed on a separate display device.

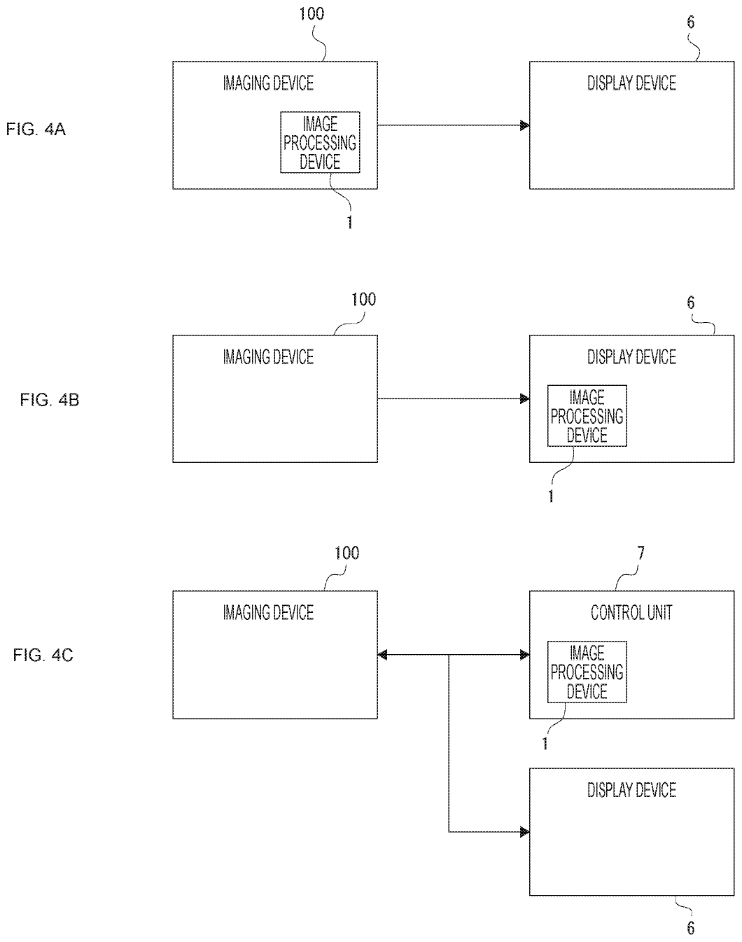

For example, FIG. 4A illustrates a configuration in which a separate display device 6 is connected to the imaging device 100. The imaging device 100 transmits the through image data to the display device 6, so that the through image is displayed on the display device 6, and the user can check the subject on the display device 6.

In the case of such a configuration, the image processing device 1 is provided in the imaging device 100, and the image processing device 1 generates combined image data of the through image data and the clipped image data. Then, the combined image data is transmitted to and displayed on the display device 6, so that both the through image and the clipped image for focus assist can be viewed on the display device 6.

Furthermore, as illustrated in FIG. 4B, the image processing device 1 may be provided on the display device 6 side.

That is, the imaging device 100 transmits the captured image data to the display device 6. The display device 6 performs resolution conversion from the captured image data to generate through image data and generate clipped image data, and displays the through image data and the clipped image data. Thus, the user can view both the through image and the clipped image for focus assist on the display device 6.

FIG. 4C illustrates a mode in which the imaging device 100, the display device 6, and the control unit 7 are connected. In this case, an example is conceivable in which the image processing device 1 is provided in the control unit 7. The image processing device 1 generates through image data, generates clipped image data, generates combined image data of the clipped image data, and transmits the combined image data to the display device. Thus, the user can see both the through image and the clipped image for focus assist on the display device 6.

Of course, even in a case where the control unit 7 is connected, an example in which the image processing device 1 is provided in the imaging device 100 and an example in which the image processing device 1 is provided in the display device 6 are also conceivable.

Furthermore, although not illustrated, an example is also conceivable in which the image processing device 1 is provided in a cloud server, generates through image data and clipped image data via network communication, and transmits the through image data and the clipped image data or combined image data thereof to the display device 6 for display.

### 2. FIRST EMBODIMENT

Hereinafter, the image processing device 1 of the embodiment will be described in detail.

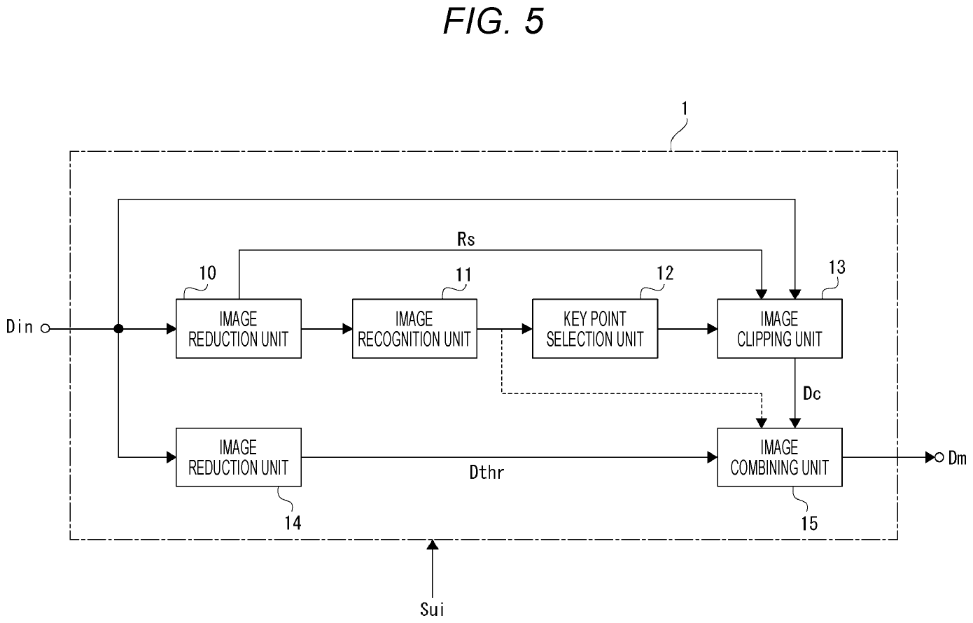

FIG. 5 illustrates a configuration example of the image processing device 1. The image processing device 1 includes an image reduction unit 10, an image recognition unit 11, a key point selection unit 12, an image clipping unit 13, an image reduction unit 14, and an image combining unit 15. These may be configured by software or may be configured by hardware.

Input image data Din is input to the image processing device 1. The input image data Din is, for example, captured image data subjected to development processing in the camera signal processing unit 113 in FIG. 3, and for example, image data before resolution conversion for a through image is assumed. For example, also in a case where the image processing device 1 is mounted in addition to the imaging device 100 as illustrated in FIGS. 4B and 4C, it is assumed that the captured image data is transmitted from the imaging device 100.

As a more specific example, it is assumed that the input image data Din is high-definition image data such as 4K or 8K.

The input image data Din is supplied to each of the image reduction unit 10, the image clipping unit 13, and the image reduction unit 14.

The image reduction unit 10 performs image size reduction processing on the input image data Din. This is because it takes a lot of time if the subject recognition processing of the image recognition unit 11 at the subsequent stage is processed with high-definition image data such as 4K, and an image having a small size such as VGA (640×480 pixels) or QVGA (320×240 pixels) is used by the reduction processing.

Note that the image reduction unit 10 notifies the image clipping unit 13 of a reduction ratio RS in the executed reduction processing.

The image recognition unit 11 performs subject recognition processing on the image reduced by the image reduction unit 10. Specifically, the image recognition unit 11 recognizes a person included in the image as a subject and a face, an eye, a hand, and the like that are parts of a person, and detects these as key points.

The key point is, for example, a subject (target subject) that can be a focus target among all subjects included in an image and is a possibility for displaying a clipped image for focus assist.

For example, deep learning is used to detect such key points. A part of a human body such as a joint of a hand or a foot, an eye, a nose, or an ear is detected as a key point from image data by using a deep learning technology, and a coordinate position in the image is detected.

The coordinate positions of one or more key points detected by the image recognition unit 11 are sent to the key point selection unit 12. The key point selection unit 12 selects a key point that is effective as a guide when manual focusing is performed. For example, only a pupil or a face may be selected as a specific part of a human body. For example, key points may be selected from parts of a face in order of priority such as a left eye, a right eye, a right ear, a left ear, a mouth, and a nose.

The reason why the eye (pupil) is prioritized here is that the eye is a characteristic key point used also in autofocus. Furthermore, in a case where no eye is found, key points such as an ear are used.

The coordinate position of the key point selected by the key point selection unit 12 is sent to the image clipping unit 13.

The image clipping unit 13 converts the coordinate position of the key point into the coordinate position in the image to be subjected to clipping processing, from the coordinate position of the key point sent from the key point selection unit 12 and the reduction ratio RS sent from the image reduction unit 10.

In this example, it is assumed that the image clipping unit 13 performs the clipping processing from the input image data Din which is the original image before the reduction processing. Therefore, image clipping unit 13 converts the coordinate position of the key point into the coordinate position in the input image data Din.

Then, the image clipping unit 13 performs image clipping processing from the input image data Din with a preset image size centered on the key point coordinate position.

In a case where a plurality of key point coordinate positions has been sent, the image clipping processing as described above is performed for the number of sent coordinate positions.

Then, the image clipping unit 13 sends one or more pieces of clipped image data Dc to the image combining unit 15.

On the other hand, the image reduction unit 14 also performs reduction processing on the input image data Din. The image reduction unit 14 performs reduction processing for generating through image data Dthr, that is, conversion into low resolution.

Accordingly, the through image data Dthr and the clipped image data Dc from the image reduction unit 14 are supplied to the image combining unit 15, and the image combining unit 15 performs combining processing thereof.

The image combining unit 15 performs, for example, combining processing in such a manner that a through image and a clipped image are simultaneously visually recognizable in one screen, and outputs combined image data Dm. The combined image data Dm is sent to a display device (the display device 6, the display panel 201, the view finder 202, and the like) and displayed for the user. Thus, the user can visually recognize the through image and the clipped image.

Note that although the image combining unit 15 performs the combining processing, the through image data Dthr and the clipped image data Dc may be output separately, and the through image and the clipped image may be displayed on different display devices.

Here, a display state in a case where the image clipping unit 13 simply performs clipping based on the key point will be described as a comparative example, and then the processing of the present embodiment will be described.

For example, it is assumed that the image clipping unit 13 sets the clipping range of the image around the coordinate position of the key point sent from the key point selection unit 12. It is assumed that eyes are selected as key points.

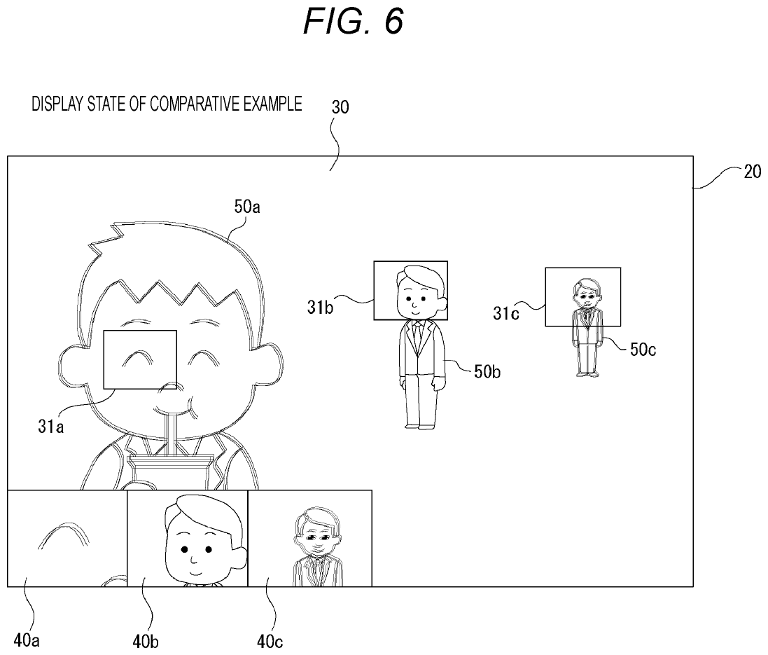

Then, the display (comparative example) based on the combined image data Dm is as illustrated in FIG. 6.

FIG. 6 illustrates a state displayed on the screen 20 of the display device. In this example, it is assumed that persons 50a, 50b, and 50c exist as subjects, and the image clipping processing is performed with the eyes of the persons 50a, 50b, and 50c as key points. Then, an image combined in such a manner that a clipped image 40 (40a, 40b, and 40c) is superimposed on the through image 30 is displayed.

On the through image 30, a focus frame 31 (31a, 31b, and 31c) is displayed and indicates that this is a possibility for the focus target and indicates that it is a region that has been subjected to the clipping processing.

Furthermore, FIG. 6 illustrates a state where the person 50b is focused, and the person 50a closer to the imaging device 100 and the person 50c farther from the imaging device 100 are blurred images.

In this manner, by displaying the clipped image 40 and further causing the clipped image 40 to be an image having a higher resolution than the through image 30, it becomes easy for the user to check the focus state with respect to the subject of an in-focus target, and become an assist of the manual focus operation.

The reason why the resolution of the clipped image 40 is high is that the image clipping unit 13 performs the clipping processing from the input image data Din that has not been subjected to the reduction processing.

Note that, for the sake of description, the focus frame, the clipped image, and the person are referred to as a “focus frame 31”, a “clipped image 40”, and a “person 50”, respectively, when collectively referred to, and are identified by adding alphabets such as a “focus frame 31a”, a “clipped image 40a”, and a “person 50a”, respectively, when indicated individually.

In the case of FIG. 6, when the size of the face is sufficiently larger than the size of the image to be clipped, the key point (the right eye in this case) is arranged at the center of the image in the clipped image 40. For example, in the clipped image 40a of the person 50a, the right eye is arranged at the center.

On the other hand, when the size of the face is smaller than the size of the image to be clipped, most of the face is displayed in the clipped image 40, but the position of the face is shifted to one side by centering the position of the right eye, which deteriorates the appearance. That is, in the clipped images 40b and 40c, the face is not at the center in the clipped image 40. This is actually noticeable as a visual impression from the user, and the user feels that the product quality is low. Furthermore, the background other than the face becomes conspicuous in the clipped image 40. For these reasons, there is a waste in the region of the clipped image 40, and the clipped image is not suitable as an image for focus assist.

Accordingly, in the present embodiment, when performing the clipping processing for a key point, the image clipping unit 13 sets the clipping region according to the image size of the specific portion related to the key point and performs the clipping processing.

For example, it is assumed that an image size of a specific portion related to the key point is an image size of a face in a case where the key point is a face or an eye, an ear, or the like that is a part of the face.

Specifically, in a case where the face size of the person is small, the center of the clipping position is not set to the coordinate position of the key point, and the face is made to fall within the entire clipped image 40. For example, an X coordinate of the center position of clipping is adaptively changed by the following equation.

X=Xcenter . . . (case 1: when S<W)

X=α·Xeye+(1−α)·Xcenter . . . (case 2: when S<β·W)

X=Xeye . . . (case 3: other cases)
Xcenter is an X coordinate value of the center of the face, Xeye is an X coordinate value of the eye, S is an X size of the face, and W is an X size of the clipped image 40.
α is a value determined as α=(S−W)/(W·(β−1)).
β is a constant defined in advance and has a value larger than 1. For example, β=about 1.2 is assumed, but this is an example and the β value may be smaller or larger.

Case 1 described above means that, when the X size (S) of the face is smaller than the X size (W) of the clipped image 40, the center coordinates of the face, not the position coordinates of the eyes selected as the key points, are set as the center coordinates of the clipping region.

Furthermore, case 3 means that when the X size (S) of the face is larger than the X size (W) of the clipped image 40 and does not correspond to case 2, the position coordinates of the eye selected as the key point are set as the center coordinates of the clipping region.

Case 2 is a case where adjustment is performed so as not to cause a feeling of discomfort according to an intermediate state thereof, and is a case where the center coordinates of the clipping region are set such that the position of the eye is not largely deviated from the center and a deviation of the position of the face is not noticeable in a range in which the X size (S) of the face is equal to or larger than the X size (W) of the clipped image 40.

The center coordinate of the clipping region is adaptively determined according to the size of the specific portion related to the key point as described above, and thereby the clipping region itself is adaptively set. That is, the clipped region is adjusted according to the center coordinates.

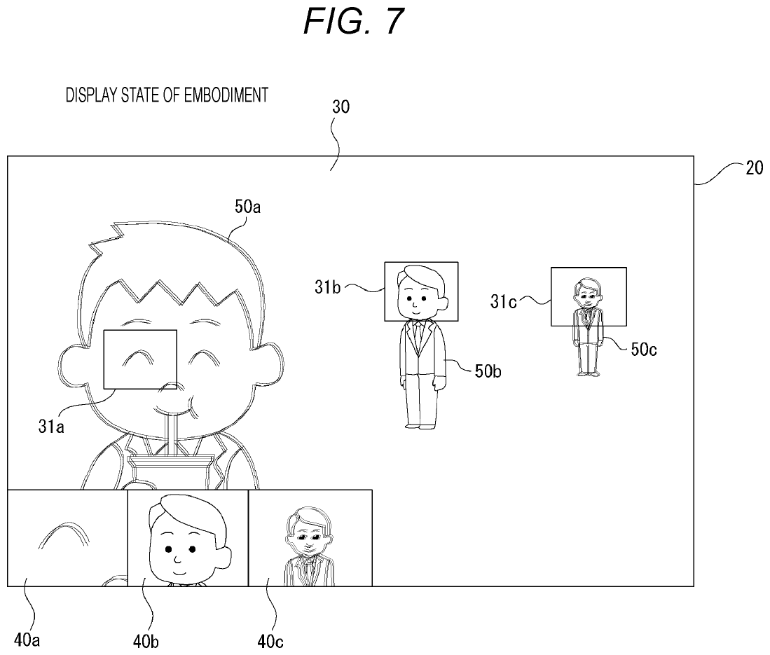

Thus, image display as illustrated in FIG. 7 can be performed.

Also in the case of FIG. 7, clipped images 40a, 40b, and 40c in a case where the right eye (or the face) of each person 50 is used as a key point are displayed similarly to FIG. 6. However, in the clipped image 40a in a case where the face size is large, the right eye is positioned at the center, and in the clipped images 40b and 40c in which the face size is small, the entire face is positioned at the center.

Thus, the visual impression of the clipped image 40 is improved, and the quality as a display image is improved. Furthermore, conspicuousness of other than the target subject, for example, the background in the clipped image 40 is solved.

Moreover, since the clipped image 40 is an image having a higher resolution than the through image 30, the user can easily perform fine adjustment of the focus state by the clipped image 40.

In particular, in a case where the resolution of the display device is lower than the resolution of the captured image data (input image data Din), the through image data Dthr is generated by performing the reduction processing, and the through image 30 is displayed. Thus, it may be difficult for the user to understand a fine focus state only with the through image 30. Even under such a situation, since the clipped image 40 is clipped with the resolution of the input image data Din, it is easy to perform visual checking at the time of the focus operation.

Note that, although only the X coordinate value has been described above, the Y coordinate value can also be calculated by a similar expression. Alternatively, regarding the Y coordinate, the center position of the clipping region may be fixed to the Y coordinate of the key point.

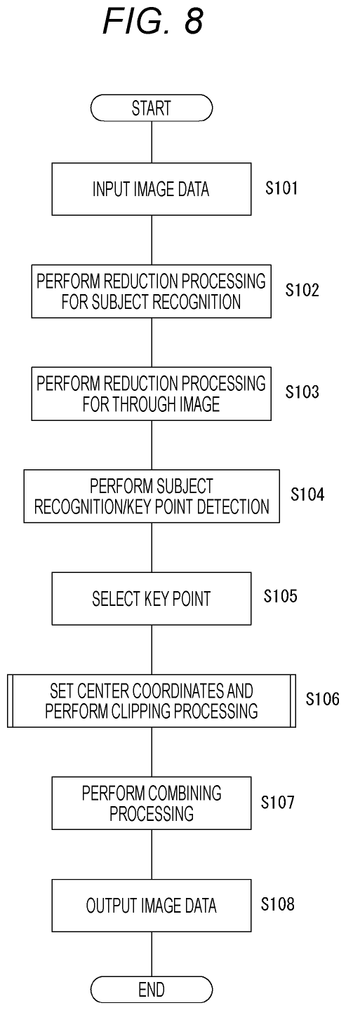

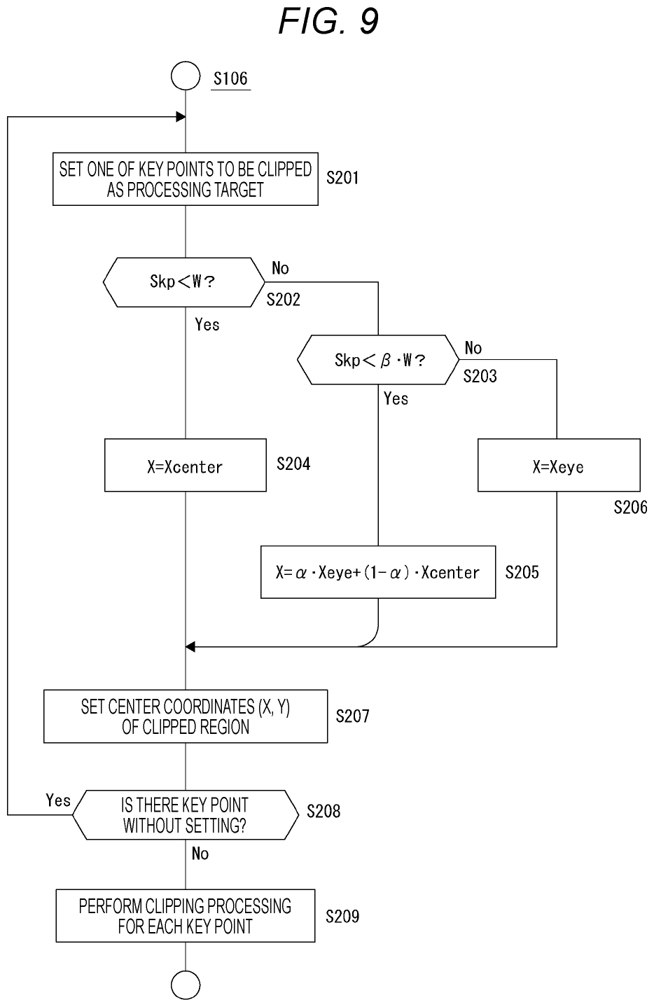

The configuration of the image processing device 1 as illustrated in FIG. 5 can be achieved as software in a DSP or a microcomputer. For example, by a program that causes an arithmetic processing device to execute the processing illustrated in FIGS. 8 and 9, the arithmetic processing device is implemented as the image processing device 1 of the embodiment.

Processing of FIGS. 8 and 9 of the image processing device 1 based on such a program will be described.

The processing of FIG. 8 is performed, for example, for each frame of the input image data Din. In step S101, the image processing device 1 acquires input image data Din of one frame.

In step S102, the image processing device 1 performs reduction processing for subject recognition processing on the input image data Din. This processing is, namely, the processing of the image reduction unit 10 described above.

In step S103, the image processing device 1 performs reduction processing for generating the through image data Dthr on the input image data Din. This processing is, namely, the processing of the image reduction unit 14 described above.

In step S104, the image processing device 1 performs processing of the image recognition unit 11. That is, the image processing device 1 performs image analysis of the current frame, performs the subject recognition processing, and detects the recognized specific subject as a key point. For example, subject recognition of a face, eyes, ears, and the like is performed, and using these as key points, the coordinate position of each key point is determined.

In step S105, the image processing device 1 performs processing of the key point selection unit 12. That is, the image processing device 1 selects one or more key points to be clipped as an image for focus assist from among subjects detected as the key points.

In step S106, the image processing device 1 performs processing of the image clipping unit 13. That is, the image processing device 1 sets the center coordinates as the clipping region for one or more selected key points as indicated by the above equation, and executes the clipping processing. Thus, the clipped image data Dc is obtained.

The processing of step S106 is illustrated in detail in FIG. 9.

In step S201, the image processing device sets one of the key points selected as clipping targets as a processing target.

Then, for the key point as the processing target, the processing branches in steps S202 and S203 according to an X size Skp of the image of the specific portion (for example, the face) related to the key point.

If the X size Skp of the image of the specific portion related to the key point is smaller than the X size W of the clipped image 40, this is a case corresponding to the above-described case 1, and the image processing device 1 proceeds from step S202 to step S204 and sets X=Xcenter.

A case where the X size Skp satisfies Skp<β·W corresponds to the above-described case 2, and the image processing device 1 proceeds from step S203 to step S205 and sets X=α·Xeye+(1−α)·Xcenter.

A case where the X size Skp does not satisfy Skp<β·W corresponds to the above-described case 3, and the image processing device 1 proceeds from step S203 to step S206, and sets X=Xeye.

Then, in step S207, the image processing device 1 sets the center coordinates (X, Y) of the clipping region related to the key point.

In step S208, the image processing device 1 checks, as the clipping processing as another key point, the existence of a key point without setting of the center coordinates (X, Y), and if the key point exists, the processing from step S201 to step S207 is performed on the key point without the setting.

After setting the center coordinates of the clipping processing for each selected key point, the image processing device 1 proceeds to step S209 and performs the clipping processing for each key point. Thus, the clipped image data Dc for each key point is obtained.

Subsequently, in step S107 in FIG. 8, the image processing device 1 performs processing of the image combining unit 15. That is, the image processing device 1 performs the combining processing of the through image data Dthr and one or more pieces of the clipped image data Dc to generate the combined image data Dm.

Then, in step S108, the combined image data Dm is output.

By the above processing, image display as illustrated in FIG. 7 is performed on the display device, and the user can perform manual focus operation while checking the through image 30 and the clipped image 40.

Here, image combining processing in the image combining unit 15 will be described.

First, in the example illustrated in FIG. 7, the through image 30 is displayed on the entire screen 20, and when the face of the person 50 is detected as the subject and the clipped image data Dc is generated, the clipped image 40 is displayed to be superimposed on a part of the through image 30.

By performing the combining processing in such a manner that the clipped image 40 is superimposed on the through image 30 in this manner, in particular, in a case where no key point is detected or in a case where there is no key point to be selected as the clipped image 40 even if the key point is detected, the through image 30 is displayed on the entire screen 20, so that there is no waste of the screen region.

In addition, since the clipped image 40 appears in response to the detection and selection of a key point, the user can easily recognize the presence of a focus target.

Note that, in a case where the clipped image 40 is superimposed on the through image 30 in this manner, an overwriting start position, an overwriting direction, and an upper limit number of overwrites are set in advance.

As the number of clipped images 40 increases, the faces are displayed side by side in the overwriting direction. Then, the faces are displayed until the number reaches a preset upper limit number.

In the example of FIG. 7, it is conceivable that the lower left of the screen is set as the overwriting start position, the overwriting direction is the right direction, and the upper limit number of overwrites is, for example, five.

By the way, in a case of the above-described overwriting display, by overwriting the clipped image 40 on the through image 30, a part of the through image 30 is hidden.

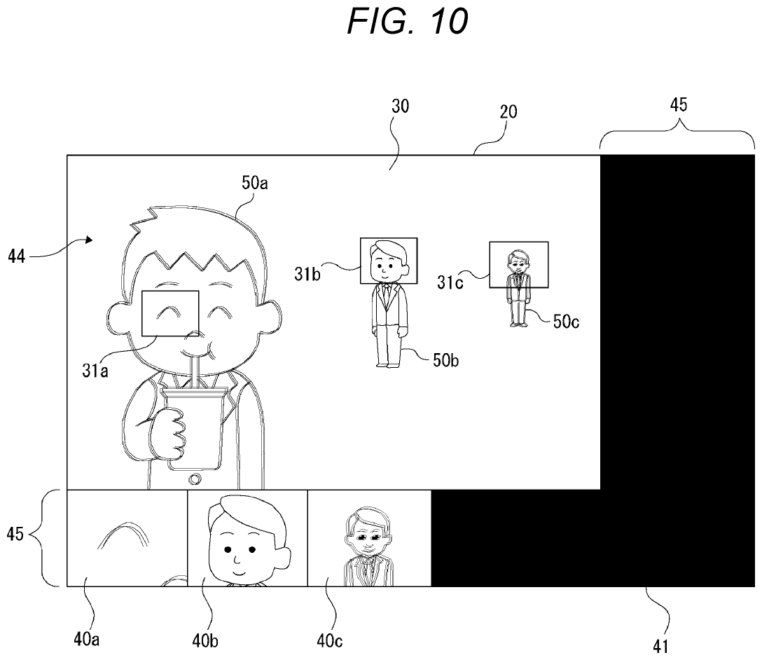

Accordingly, as illustrated in FIG. 10, the through image area 44 and the clipped image area 45 may be divided and set, and the combining processing may be performed in such a manner that each image is applied. That is, the through image 30 is not displayed on the entire screen 20 of the display device, but is partially displayed with a margin. Then, lower and right margin portions of the screen 20 are set as the clipped image area 45, and when the clipped image data Dc is obtained, the combining processing is performed in such a manner that the clipped image 40 is displayed in the margin portion.

In this case, the upper limit of the number of displayed clipped images 40 depends on the size of the clipped image area 45 as a margin.

As still another combining processing, the combining processing of displaying the clipped image 40 near the image of the key point in the through image 30 is also considered.

In the display in the above-described cases of FIGS. 7 and 10, there is a case where it is difficult to understand the positional relationship of each clipped image 40 in the through image 30. That is, it may be difficult to understand which image in the through image 30 the clipped image 40 enlarges.

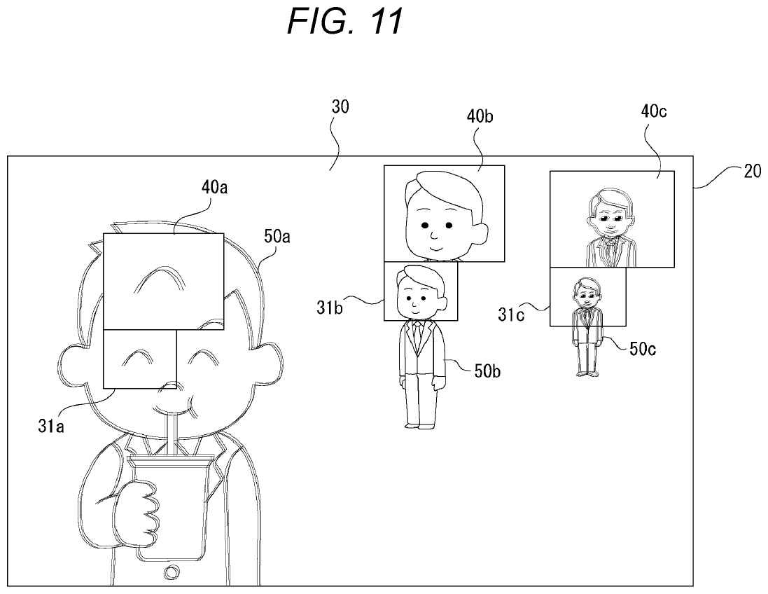

Accordingly, as illustrated in FIG. 11, the clipped image 40 for the key point is superimposed and displayed near the image of the key point in the through image 30.

In this manner, the user can quite easily grasp which portion in the through image 30 the clipped image 40 enlarges.

Note that, in this case, the image combining unit 15 needs the coordinate values of the respective key points in order to determine the position to combine the clipped image data Dc. Accordingly, as indicated by a broken line in FIG. 5, it is conceivable that the image combining unit 15 performs processing of acquiring coordinate values of each key point from the image recognition unit 11 and determining a combined position of the clipped image data Dc on the through image data Dthr on the basis of the coordinate values.

Although three examples have been described above as display examples, display examples other than these are of course also conceivable.

Furthermore, for example, the display mode as illustrated in FIGS. 7, 10, and 11 may be switched by operation by the user, and may be selected according to a use case or preferences.

### 3. SECOND EMBODIMENT

A second embodiment will be described. In the first embodiment described above, in a case where, for example, the number of faces to be key points increases in the input image data Din and exceeds the upper limit of the number of displayed clipped images 40, there is a case where a face desired by the user, that is, a face desired to be a focus target is not displayed as the clipped image 40. Accordingly, rules of priority order of key points (for example, a face) to be displayed may be set in advance.

For example, key points are selected as key points as clipping targets in descending order of the face size, and the clipped image 40 is displayed.

Furthermore, key points may be selected as key points as clipping targets in ascending order of the face size, and the clipped image 40 may be displayed.

In addition, a face size to be preferentially displayed may be set in advance, a face close to the set face size may be preferentially selected as a key point as a clipping target, and the clipped image 40 may be displayed.

Furthermore, a display priority position (for example, the center of an image) may be set in advance, a face closer to the priority position may be preferentially selected as a key point as a clipping target, and the clipped image 40 may be displayed.

These rules may be used singly or in combination of two or more.

### 4. THIRD EMBODIMENT

Furthermore, considering that a desired face may not be clipped and displayed in a case where the number of key points (for example, faces) increases in the input image data Din and exceeds the upper limit of the number of displayed clipped images 40, it is also conceivable to select a key point as a clipping target using the user interface.

FIG. 5 illustrates that operation information Sui is input to the image processing device 1. The operation information Sui is operation information of the user input with the user interface.

For example, the key point selection unit 12 selects a key point as a clipping target on the basis of the operation information Sui.

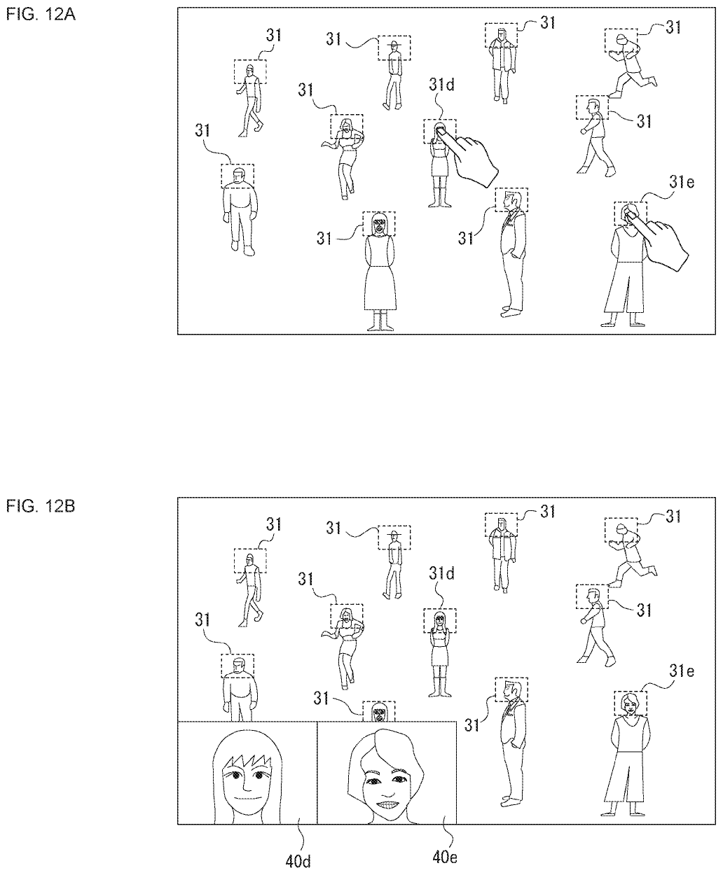

FIG. 12A illustrates a state in which the through image 30 is displayed on the screen 20 of the display device. This is an example of a case where a face is used as a key point, but in this case, a state is illustrated in which there are many detected faces and all of them are indicated by the focus frame 31. However, since the number of detected faces is too large, a clipping target is not determined, and the clipped image 40 is not displayed.

In such a case, the user selects a desired face through the user interface such as a touch operation, a cursor operation, or a touch pen operation. For example, it is assumed that an operation of selecting faces indicated by focus frames 31d and 31e is performed.

In this case, the operation information Sui designating the focus frames 31d and 31e is input to the image processing device 1, and the key point selection unit 12 selects a key point according to the operation information. The image clipping unit 13 then generates the clipped image data Dc for the selected key point. Thus, on the screen 20, clipped images 40d and 40e of the faces designated by the user are displayed as illustrated in FIG. 12B. That is, the subject desired to be a focus target by the user is displayed as the clipped image 40.

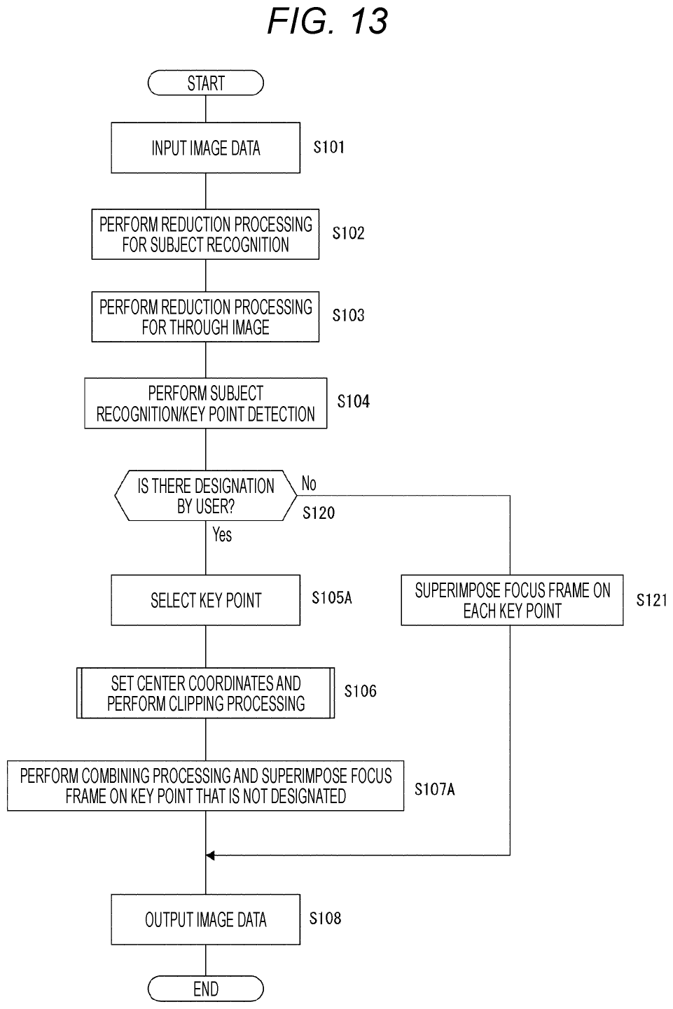

FIG. 13 illustrates a processing example of the image processing device 1 in such a case. Note that processes similar to those in FIG. 8 are denoted by the same step numbers, and redundant description is avoided.

Upon detecting the key point in step S104, the image processing device 1 branches the processing depending on the presence or absence of a designation operation by the user in step S120.

In a period in which there is no designation operation by the user, the process proceeds from step S120 to step S121, and the focus frame 31 is superimposed and displayed for each key point. For example, as indicated by a broken line in FIG. 5, the image combining unit 15 is only required to acquire coordinate values of each key point from the image recognition unit 11, and perform processing of combining the focus frame 31 on the basis of the coordinate values.

Thus, for example, display as illustrated in FIG. 12A is executed.

Thereafter, it is assumed that the user performs an operation of selecting a subject desired to be focused as a focus target. In this case, the processing of FIG. 13 proceeds from step S120 to step S105A.

In step S105A, the image processing device 1 selects a key point as a clipping target on the basis of the operation information Sui.

In step S106, the image processing device 1 performs the clipping processing for the selected key point.

In step S107A, the image processing device 1 performs the combining processing of the clipped image data Dc obtained as a result of the clipping processing and the through image data Dthr. Furthermore, at this time, the focus frame 31 is continuously displayed for the key points that are not clipping targets. Thus, the display as illustrated in FIG. 12B is executed.

For the user, for example, by continuously displaying the focus frame also on a face that is not designated even after designating one key point (for example, a face), another face can be additionally designated, and the clipped image 40 can be displayed.

Thus, the user can finely check the focus state of one or more desired key points by using the clipped image 40.

Note that when the number of displayed clipped images 40 reaches the upper limit number, the display of focus frame 31 for an undesignated face may be ended so that other faces cannot be designated.

Furthermore, the user may perform an end operation on the clipped image 40, and the clipped image 40 subjected to the end operation may be turned off. In addition, the user may be allowed to perform a designation operation so as to display the focus frame 31 on an undesignated face and display the clipped image 40 up to the upper limit number.

Furthermore, in a case where any position can be designated on the screen as in a touch panel operation, even in a case where there is no key point such as a person's face at the touched position, an image may be clipped around the touched position and displayed as the clipped image 40.

For example, when the user wants to focus on a specific object, a scene, or the like that is not normally recognized as a key point, it is preferable that the clipped image 40 of that portion is displayed.

### 5. FOURTH EMBODIMENT

In the first to third embodiments described above, an example has been described in which a key point with respect to a person is detected, and an image around the key point is displayed on the display device without being reduced, thereby supporting visual checking at the time of manual focus.

However, the focus target may be not only a person but also an animal or an object such as a car. Accordingly, an object may be detected as a key point using a technique of detecting a general object region such as an animal or a car, and the detected object region may be clipped and displayed on the display device.

In this case, what object is to be displayed may be determined in advance, and a desired object region may be clipped from the detected object region and displayed.

At that time, priority may be given as described in the second embodiment. In this case, not only the size and position of the object but also the type of the object may be set as a target of priority order.

Furthermore, as in the third embodiment, a key point as a clipping target may be selected using the user interface.

### 6. FIFTH EMBODIMENT

As illustrated in FIG. 10 described above, in a case where the through image area 44 and the clipped image area 45 are separated from each other, some sort of display may be performed in the clipped image area 45 particularly when no key point is detected and the clipped image 40 is not displayed. That is, the clipped image area 45 is not wasted.

Accordingly, the same number of fixed regions as or smaller number of fixed regions than the number of objects that can be displayed in the margin portion are set in advance, and in a case where the number of detected key points is small, an image around the fixed region is clipped and displayed.

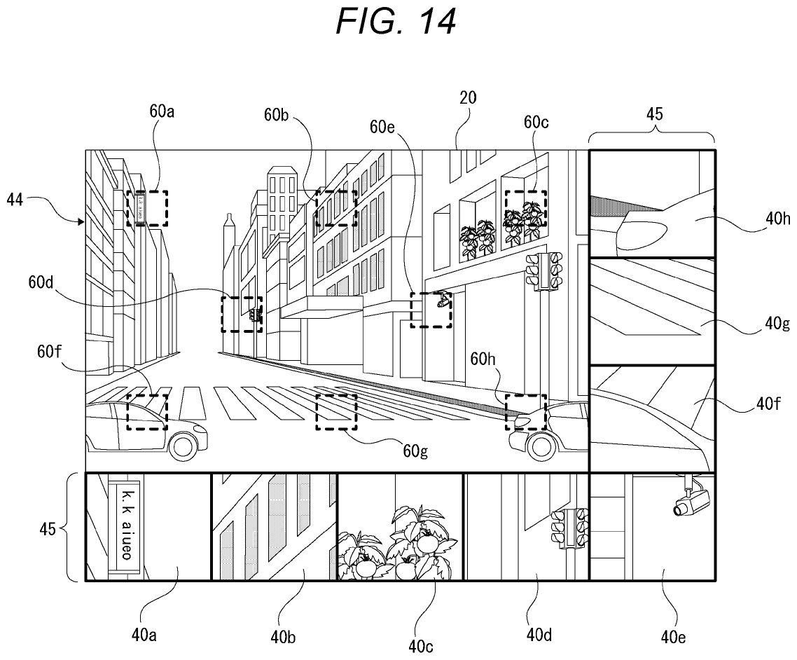

FIG. 14 illustrates an example in which eight fixed regions 60 (fixed regions 60a to 60h) are set and displayed in the through image 30 in the through image area 44. Note that the frame indicating the fixed region 60 may not be displayed.

Furthermore, in the clipped image area 45 provided below and on the right of the screen 20, eight clipped images 40 can be displayed. Then, the clipped image 40a is displayed as a clipped image around a fixed region 60a, the clipped image 40b is displayed as a clipped image around a fixed region 60b, the clipped image 40c is displayed as a clipped image around a fixed region 60c, . . . and a clipped image 40h is displayed as a clipped image around a fixed region 60h.

While no key point is detected, the display as described above is performed, and in a case where a key point is detected, the clipped image 40 for the key point is displayed instead of the clipped image 40 of the fixed region close to the position of the detected key point.

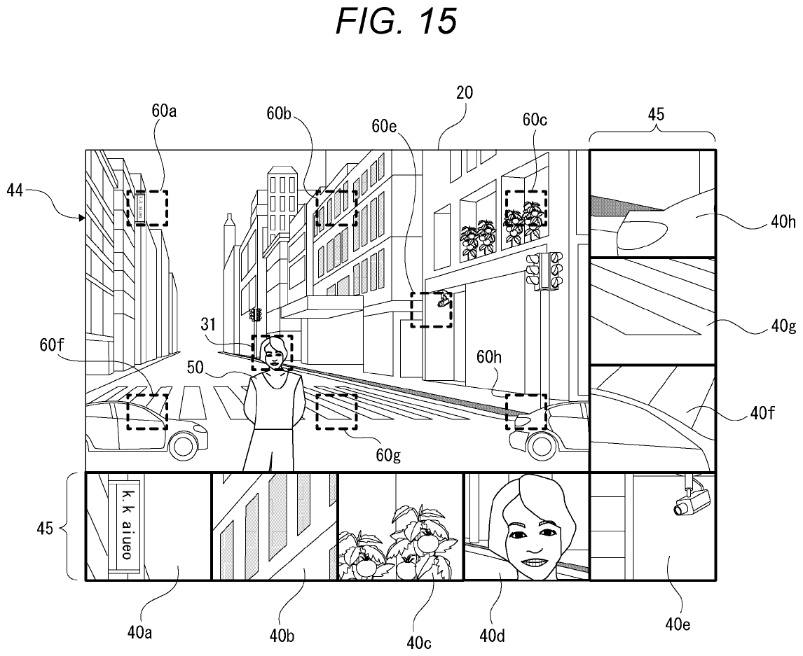

In FIG. 15, in a case where a person 50 appears slightly lower left of the center of the screen, the focus frame 31 is displayed with the face as a key point. Then, in the clipped image area 45, the clipped image 40d based on the key point is displayed instead of the image of a fixed region 60d.

In this manner, the clipped image 40 can be displayed using the entire screen region even in a period in which no key point is detected or a period in which the number of key points set as the clipped image 40 does not reach the upper limit number.

Even if the key point cannot be detected, it may be convenient for the operation of the user by enlarging and displaying each position on the screen.

In order to perform such display, for example, in step S106 in FIG. 8, the image processing device 1 generates the clipped image data Dc of a fixed region where no key point is detected around the fixed region. That is, in a case where the key point is selected, the clipped image data Dc of the key point is generated, and the clipped image data Dc around the fixed region 60 where the key point does not exist is generated. Thus, eight pieces of the clipped image data Dc are generated.

Then, in the combining processing in step S107, the image processing device 1 performs the combining processing of frames presenting the fixed regions 60, and performs the combining processing in such a manner that the eight pieces of the clipped image data Dc are arranged in respective clipped image areas 45.

### 7. SIXTH EMBODIMENT

As a sixth embodiment, an example in which peaking display is performed will be described.

The peaking display may be performed as a support function at the time of visual checking of manual focus. The peaking display is a display in which an in-focus portion is clearly indicated to the user by coloring an edge that is likely to be in focus in the image, or the like.

This peaking display is useful in the sense of clearly indicating an in-focus portion, for example, in a case where it is difficult to visually check the manual focus due to a difference in resolution between the captured image and the display device.

However, the peaking display displays an edge that is likely to be in focus, and there is no guarantee that it is always in focus. Nevertheless, since the color is added to an edge portion that is most useful for visual checking of manual focus, it becomes difficult to make fine adjustments in manual focus.

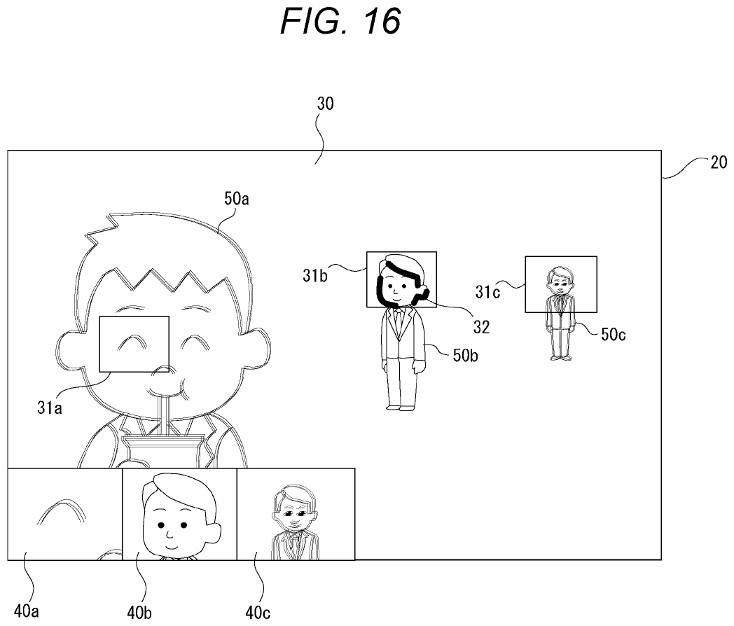

Accordingly, as illustrated in FIG. 16, the peaking display 32 is executed on the through image 30, but the peaking display is not performed on the clipped image 40.

Thus, the user can roughly adjust the focus while viewing the peaking display 32 of the through image 30, and then view the clipped image 40 and finely adjust the focus. By performing the peaking display 32 on the through image 30, it is easy to roughly perform the focus operation so as to focus on the target subject while checking the entire subject. In addition, since the peaking display is not performed on the clipped image 40, the focus state can be finely adjusted while checking a slight degree of blurring of the edge portion of the image.

Furthermore, in the example of FIG. 16, in particular, also in the through image 30, the peaking display 32 is performed only on the inside of the focus frame 31, and the peaking display is not performed even if there is an in-focus portion other than that.

As another problem of the peaking display, in a case where there are many edges that are likely to be focused on the image, colors are applied to various places of the image, and the image may be difficult to see. Accordingly, the peaking display 32 is performed only around the detected key point, that is, in the focus frame 31 as illustrated in FIG. 16, instead of performing the peaking display on the entire through image 30.

Thus, the through image 30 does not become an annoying image due to the peaking display 32, and a rough focus operation becomes easy.

Note that the intensity of peaking around the detected key point or the number of pixels to be peaked may be counted, and a region exceeding the threshold may be detected as a region that is likely to be in focus. The detected region may be displayed by coloring the frame of the clipped image 40, or only the detected region may be combined and displayed as the clipped image 40.

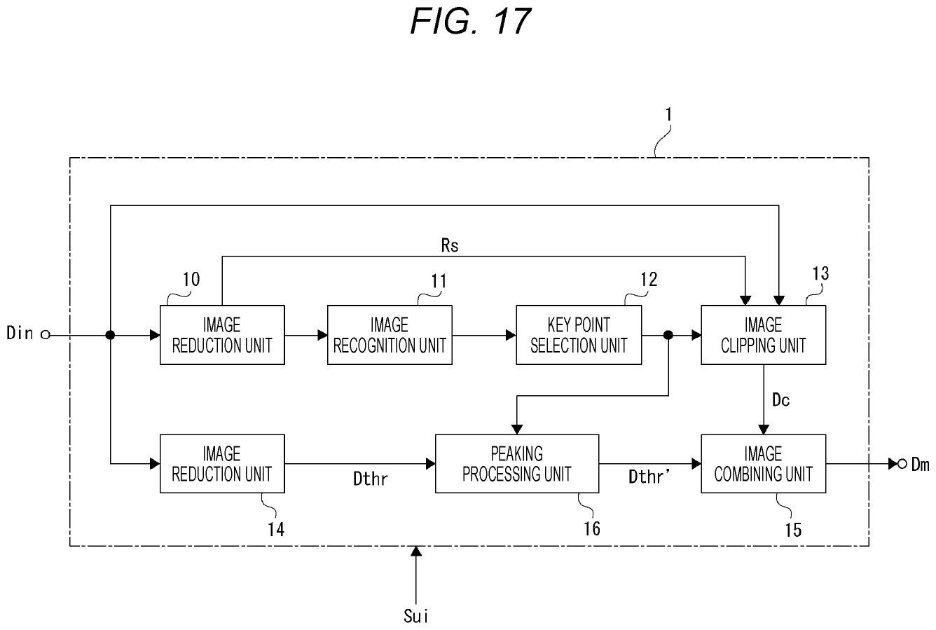

FIG. 17 illustrates a configuration example for the peaking display 32. This is an example in which a peaking processing unit 16 is added to the above-described configuration of FIG. 5.

The peaking processing unit 16 determines an in-focus pixel for the through image data Dthr output from the image reduction unit 14, and performs processing of adding a color indicating peaking to the in-focus pixel. However, the position coordinates of key points selected by the key point selection unit 12 are also acquired, the range of the focus frame 31 is recognized, and processing of the peaking display is performed only within the range.

Then, through image data Dthr′ subjected to the peaking processing is sent to the image combining unit 15.

When the clipped image data Dc and the through image data Dthr′ are combined in the image combining unit 15, the display as illustrated in FIG. 16 is executed.

Note that, although the peaking processing unit 16 performs peaking display processing on the through image data Dthr, the determination of an in-focus pixel may be performed more precisely by using, for example, the input image data Din.

### 8. SEVENTH EMBODIMENT

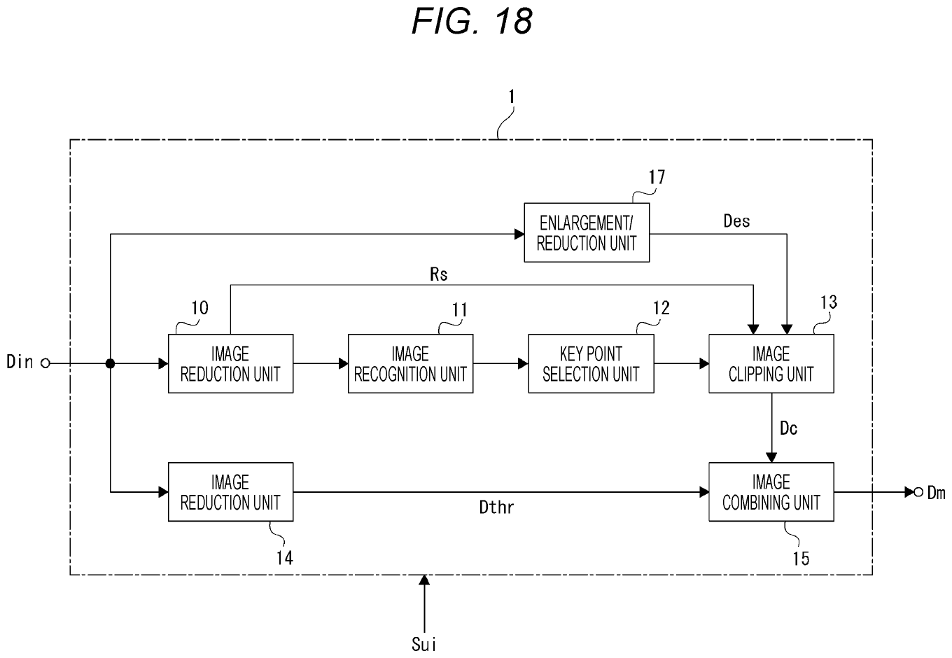

FIG. 18 illustrates a configuration example of the image processing device 1 of the seventh embodiment. This is obtained by adding an enlargement-reduction unit 17 to the above-described configuration of FIG. 5.

The enlargement-reduction unit 17 performs enlargement processing or reduction processing on the input image data Din. Then, enlarged or reduced image data Des is supplied to the image clipping unit 13. The image clipping unit 13 performs the clipping processing on image data Des to generate the clipped image data Dc.

In this case, as the reduction processing, the resolution of the input image data Din is reduced, but this reduction ratio is made smaller than the reduction ratio to the through image data Dthr by the image reduction unit 14. That is, it is assumed that the image data Des has a higher resolution than the through image data Dthr. Thus, it is possible to maintain that the clipped image 40 has a resolution higher than that of the through image 30, and it is possible to obtain an image suitable for checking the focus state.

The enlargement-reduction unit 17 may generate the image data Des in which the resolution of the input image data Din is further increased by, for example, a super-resolution technology or the like.

In this case, it is possible to display the clipped image 40 with higher definition.

### 9. SUMMARY AND MODIFICATION EXAMPLE

In the above embodiments, the following effects can be obtained.

The image processing device 1 of the first to seventh embodiments includes the image clipping unit 13 that sets a clipping region for a key point (target subject) as a display possibility of a clipped image in the input image data Din according to an image size of a specific portion related to the target subject, and performs the clipping processing.

Thus, an appropriate range is clipped from the input image data Din or reduced or enlarged image data Des, which are captured image data, according to the image size of the specific portion related to the key point, and is displayed as the clipped image 40 suitable for checking a focus state. Thus, it is possible to achieve display of the clipped image 40 without a feeling of discomfort.

In particular, in a case where the resolution of the display device used for visual checking at the time of focusing is lower than that of the photographed image data, it is possible to support visual checking of manual focus by displaying the through image 30 obtained by reducing the entire image, and partially clipping and displaying a region to be focused such as a face.

Note that the “specific portion related to the key point (target subject)” is only required to be determined according to the type of the key point determined by the subject recognition. For example, a key point itself may be used, or a portion as a high-order object unit including a part as a key point, or the like is assumed. Then, the specific portion is appropriately an object or a portion of an object that is easily recognized as one collective unit by the viewer when the specific portion is displayed.

For example, the following specific sites are assumed.
In a case where parts of a face such as eyes, a nose, and ears are key points, the “face” or the “whole body” that includes them as parts is set as the specific portion.
In a case where the face is a key point, the “face” is directly set as the specific portion.
In a case where a face, a foot, an upper body, a lower body, a chest, an arm, or the like is used as a key point, the “whole body” including the face, the foot, the upper body, the lower body, the chest, the arm, and the like as parts is set as the specific portion.
In a case where a face, an eye, a foot, a tail, or the like of an animal is used as a key point, the “whole body of the animal” including the face, the eye, the foot, the tail, and the like as parts is set as the specific portion.
In a case where a part of an object other than a person or an animal, for example, a tire, a headlight, or the like of a car is used as a key point, the “car” including these as parts is set as the specific portion.

Although the above is merely an example, it is preferable that the “specific portion” is set as an appropriate unit when visually recognized as a clipped image as described above.

In the first embodiment, an example has been described in which the image clipping unit 13 sets the center position of the clipping region according to the image size of the specific portion (for example, the face) related to the key point.

By setting coordinate values as the center position of the clipping region, the clipping range in which the key point is appropriately arranged in the clipped image 40 is determined. Therefore, the eye as the key point can be centered, or the face can be positioned at the center of the frame of the clipped image 40 even if the key point is the eye. Therefore, the key point is set at an appropriate position in the clipped image 40, and display of the clipped image 40 that is easy to see and does not give a feeling of discomfort can be achieved.

The image processing device 1 of the first to seventh embodiments includes the image combining unit 15 that combines the through image data Dthr obtained by reducing the resolution of the input image data Din and the clipped image data Dc generated by the clipping processing.

By generating the combined image data Dm and displaying the combined image data Dm on the display device, the through image 30 and the clipped image 40 can be simultaneously visually recognizable on one screen. The user can finely check the focus state for the key point with the clipped image 40 while checking the subject side with the through image 30.

Note that the image combining unit 15 may not be provided, and the through image 30 and the clipped image 40 may be displayed on separate display devices. Furthermore, alternatively, even if the image combining unit 15 is provided, it may be switchable between a state in which the through image 30 and the clipped image 40 are combined and displayed in one screen and a state in which they are output without being combined and are displayed on different display devices. For example, it may be adaptively switchable according to the connection state of the display device, or may be selectable by the user.

In the image processing device 1 of the first to seventh embodiments, the image clipping unit 13 performs the clipping processing from image data having a resolution higher than that of the through image data Dthr. For example, a clipping region corresponding to an image size is set for the input image data Din, and the clipping processing is performed. Alternatively, clipping is performed from the image data Des obtained by performing enlargement processing on the input image data Din Moreover, alternatively, the image data Des (resolution higher than that of the through image data Dthr) obtained by reducing the input image data Din is clipped.

Thus, the clipped image 40 becomes an image with higher resolution than the through image 30. Therefore, the focus state of the clipped image 40 is easier to check than the through image 30, and the clipped image 40 is preferable as an image for focus assist.

In the first embodiment, an example has been described in which image clipping unit 13 performs the clipping processing from input image data Din.

In a case where the resolution of the input image data Din is reduced and the through image data Dthr is generated, by clipping the clipped image 40 from the input image data Din, the clipped image 40 allows checking of the focus state more precisely than the through image 30. That is, the image is preferable as an image for focus assist.

In the first embodiment, an example has been described in which the image combining unit 15 combines the through image data Dthr and the clipped image data Dc in such a manner that the clipped image 40 is superimposed on the through image 30 (see FIGS. 7 and 11).

Thus, the clipped image 40 is superimposed on the through image 30, and can be visually recognized on one screen at the same time.

In the first embodiment, as in the example of FIG. 11, an example has been described in which the image combining unit 15 combines the through image data Dthr and the clipped image data Dc in such a manner that the clipped image 40 is superimposed near the corresponding target subject on the through image 30.

Thus, for example, the clipped image 40 is superimposed on the through image 30 and can be visually recognized on one screen at the same time, and which part of the through image 30 each clipped image 40 corresponds to can be clearly recognized.

In the first embodiment, as in the example of FIG. 10, an example has been described in which the image combining unit 15 combines the through image data Dthr and the clipped image data Dc in such a manner that the clipped image area 45 and the through image area 44 are divided on one screen.

Thus, the user can check the focus state of the key point with the clipped image in a state where the entire through image 30 can be visually recognized.

In the first and second embodiments, an example has been described in which the image recognition unit 11 that performs the subject recognition processing on the input image data Din and detects a key point (target subject) as a display possibility of the clipped image is provided, and the image clipping unit 13 performs the clipping processing on the key points selected by the key point selection unit 12 among the key points detected by the image recognition unit 11.

That is, the image recognition unit 11 can detect a plurality of target subjects by performing the subject recognition processing, but not all of them are set as targets of the clipping processing, but the target subjects are selectively set as targets of the clipping processing. For example, by selecting an appropriate key point as a focus target to obtain the clipped image 40, it is possible to avoid display of the clipped image 40 that does not contribute much to the focus assist application, and to achieve display with good recognizability for the user.

In the second embodiment, an example has been described in which the image clipping unit 13 performs the clipping processing on the key points selected by the key point selection unit 12 on the basis of the priority order set for each type of key points among the key points detected by the image recognition unit 11.

For example, the key points are selected in priority order such as left eye, right eye, right ear, left ear, mouth, and nose. Thus, appropriate key points as focus targets are automatically selected and displayed as the clipped image 40, so that it is possible to achieve display with good recognizability for the user.

In the third embodiment, an example has been described in which the image clipping unit 13 performs the clipping processing for a key point selected by operation among the key points detected by the image recognition unit 11.

For example, a key point detected on the screen is clearly indicated by the focus frame 31 or the like so that the user can select the key point by operation. Thus, the clipped image 40 can be displayed for the subject for which the user wants to check the focus state.

In the sixth embodiment, an example has been described in which the image combining unit 15 combines the through image data Dthr′ subjected to the peaking processing indicating the in-focus determination portion and the clipped image data Dc not subjected to the peaking processing.

Thus, for example, as illustrated in FIG. 16, the through image 30 and the clipped image 40 subjected to peaking display are displayed. Thus, the user can perform an operation of roughly focusing while viewing the peaking display 32 and then finely adjusting the focus state by viewing the clipped image 40. In particular, since the peaking display 32 is not performed on the clipped image 40, it is suitable for fine adjustment.

Furthermore, in the sixth embodiment, the peaking processing is a process of performing peaking display only in a region indicating a key point in the through image data Dthr.

For example, as illustrated in FIG. 16, the peaking display 32 is performed only in the focus frame 31 indicating a key point selected as an in-focus target. In this manner, it is possible to prevent checking the subject or the focus state from becoming rather difficult due to that the peaking display is performed on a background or a subject that is not to be a focus target, and the screen display content becomes complicated.

In the fifth embodiment, an example has been described in which the image clipping unit 13 performs the clipping processing of a region other than the key point detected by the image recognition unit 11.

For example, even when the target subject is not detected, the clipping region is set and clipping is performed.

Even if the key point is not detected, by displaying the clipped image 40 as illustrated in FIG. 14 for example, the clipped image area 45 can be used for display without being wasted. In some cases, the user can also perform a focus adjustment operation for a subject other than the key point by using such a clipped image 40.

In the fifth embodiment, the image clipping unit 13 performs the clipping processing for one or more fixed regions 60 on the image to display clipped images of the one or more fixed regions 60, and in a case where the image clipping unit 13 performs the clipping processing for key points, the clipped images 40 of the key points are displayed instead of the clipped images 40 of the fixed regions 60 close to the position of the key points.

That is, when the key point is detected while the clipped image 40 of the fixed region 60 on the screen is displayed, the clipped image 40 is replaced with the image of the key point from the image of the fixed region 60.

Thus, for example, as illustrated in FIG. 14, while the clipped image area 45 is used for display without waste, the clipped image of the fixed region 60 close to the position can display the clipped image of the key point as illustrated in FIG. 15 in response to the key point detection, and a focus assist function for the key point can be achieved.

As described in the first embodiment, the image recognition unit 11 performs the subject recognition processing using the image data in which the resolution of the input image data Din is reduced by the image reduction unit 10.

Thus, the processing load of the subject recognition processing can be reduced. In particular, in a case where the input image data Din is a high definition image such as 8K or 4K, the analysis processing load is heavy as it is, and the subject recognition processing with high accuracy can be performed even if the resolution is reduced to, for example, about 2K. Accordingly, it is desirable to reduce the resolution by the image reduction unit 10.

Note that the image recognition unit 11 may perform the subject recognition processing without reducing the input image data Din. In a case where the processing capability of the image recognition unit 11 is high, subject recognition accuracy can be improved by performing the subject recognition processing on an image with higher resolution.

The program of the embodiment is, for example, a program for causing a CPU, a DSP, or a device including the CPU, the DSP, or the like to execute the processing illustrated in FIG. 8, FIG. 9, or FIG. 13.

That is, the program of the embodiment is
a program for causing an arithmetic processing device to execute processing of clipping a key point (target subject) that is a display possibility of a clipped image in input image data Din by setting a clipping region according to an image size of a specific portion related to the target subject.

With such a program, the image processing device 1 of the present disclosure can be easily achieved using an arithmetic processing device.

Such a program can be recorded in advance in a hard disk drive (HDD) as a recording medium built in a device such as a computer device, a ROM in a microcomputer having a CPU, or the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as what is called package software.

Furthermore, such a program can be installed from the removable recording medium into a personal computer or the like, or can be downloaded from a download site via a network such as a local area network (LAN) or the Internet.

Note that effects described in the present description are merely examples and are not limited, and other effects may be provided.

Note that the present technology can employ configurations as follows.
(1)

An image processing device, including:
an image clipping unit that sets a clipping region for a target subject detected in input image data according to an image size of a specific portion related to the target subject, and performs clipping processing.
(2)

The image processing device according to (1) above, in which
the image clipping unit sets a center position of the clipping region according to the image size of the specific portion related to the target subject.
(3)

The image processing device according to (1) or (2) above, further including:
an image combining unit that combines through image data obtained by reducing a resolution of the input image data and clipped image data generated by the clipping processing.
(4)

The image processing device according to any one of (1) to (3) above, in which
the image clipping unit
performs the clipping processing from image data having a resolution higher than that of through image data obtained by reducing the resolution of the input image data.
(5)

The image processing device according to any one of (1) to (4) above, in which
the image clipping unit
performs the clipping processing from the input image data.
(6)

The image processing device according to (3) above, in which
the image combining unit combines the through image data and the clipped image data in such a manner that a clipped image is superimposed on a through image.
(7)

The image processing device according to (3) or (4) above, in which
the image combining unit combines the through image data and the clipped image data in such a manner that a clipped image is superimposed near a corresponding target subject on a through image.
(8)

The image processing device according to (3) above, in which
the image combining unit combines the through image data and the clipped image data in such a manner that a display region of a clipped image and a display region of a through image are divided on one screen.
(9)

The image processing device according to any one of (1) to (8) above, further including:
an image recognition unit that performs subject recognition processing on the input image data and detects a target subject as a display possibility of a clipped image, in which
the image clipping unit performs the clipping processing on a selected target subject among target subjects detected by the image recognition unit.
(10)

The image processing device according to (9) above, in which
the image clipping unit
performs the clipping processing on a target subject selected on the basis of a priority order set for each type of target subjects among the target subjects detected by the image recognition unit.
(11)

The image processing device according to (9) or (10) above, in which
the image clipping unit
performs the clipping processing on a target subject selected by an operation among the target subjects detected by the image recognition unit.
(12)

The image processing device according to (3) above, in which
the image combining unit
combines the through image data on which peaking processing indicating an in-focus determination portion has been performed and the clipped image data on which the peaking processing has not been performed.
(13)

The image processing device according to (12) above, in which
the peaking processing is processing of performing peaking display only in a region indicating the target subject in the through image data.
(14)

The image processing device according to any one of (9) to (11) above, in which
the image clipping unit performs the clipping processing of a region other than the target subject detected by the image recognition unit.
(15)

The image processing device according to (14) above, in which
the image clipping unit performs the clipping processing on one or more fixed regions on an image to display a clipped image of the one or more fixed regions, and
in a case where the image clipping unit performs the clipping processing on the target subject, a clipped image of the target subject is displayed instead of the clipped image of the fixed region close to a position of the target subject.
(16)

The image processing device according to any one of (9), (10), (11), (14), and (15) above, in which
the image recognition unit performs the subject recognition processing using image data obtained by reducing a resolution of the input image data.
(17)

An image processing method, including:
by an image processing device, setting a clipping region for a target subject detected in input image data according to an image size of a specific portion related to the target subject, and performing clipping processing.
(18)

A program for causing an arithmetic processing device to execute:
processing of setting a clipping region for a target subject detected in input image data according to an image size of a specific portion related to the target subject, and performing clipping processing.

### REFERENCE SIGNS LIST

1 Image processing device
6 Display device
7 Control unit
10, 14 Image reduction unit
11 Image recognition unit
12 Key point selection unit
13 Image clipping unit
15 Image combining unit
16 Peaking processing unit
17 Enlargement-reduction unit
20 Screen
30 Through image
31, 31a, 31b, 31c Focus frame
32 Peaking display
40, 40a, 40b, 40c, 40d, 40e, 40f, 40g, 40h Clipped image
44 Through image area
45 Clipped image area
60 Fixed region
100 Imaging device

1. An image processing device, comprising:
an image clipping unit that sets a clipping region for a target subject detected in input image data according to an image size of a specific portion related to the target subject, and performs clipping processing.

2. The image processing device according to claim 1, wherein
the image clipping unit sets a center position of the clipping region according to the image size of the specific portion related to the target subject.

3. The image processing device according to claim 1, further comprising:
an image combining unit that combines through image data obtained by reducing a resolution of the input image data and clipped image data generated by the clipping processing.

4. The image processing device according to claim 1, wherein
the image clipping unit
performs the clipping processing from image data having a resolution higher than that of through image data obtained by reducing the resolution of the input image data.

5. The image processing device according to claim 1, wherein
the image clipping unit
performs the clipping processing from the input image data.

6. The image processing device according to claim 3, wherein
the image combining unit combines the through image data and the clipped image data in such a manner that a clipped image is superimposed on a through image.

7. The image processing device according to claim 3, wherein
the image combining unit combines the through image data and the clipped image data in such a manner that a clipped image is superimposed near a corresponding target subject on a through image.

8. The image processing device according to claim 3, wherein
the image combining unit combines the through image data and the clipped image data in such a manner that a display region of a clipped image and a display region of a through image are divided on one screen.

9. The image processing device according to claim 1, further comprising:
an image recognition unit that performs subject recognition processing on the input image data and detects a target subject as a display possibility of a clipped image, wherein
the image clipping unit performs the clipping processing on a selected target subject among target subjects detected by the image recognition unit.

10. The image processing device according to claim 9, wherein
the image clipping unit
performs the clipping processing on a target subject selected on a basis of a priority order set for each type of target subjects among the target subjects detected by the image recognition unit.

11. The image processing device according to claim 9, wherein
the image clipping unit
performs the clipping processing on a target subject selected by an operation among the target subjects detected by the image recognition unit.

12. The image processing device according to claim 3, wherein
the image combining unit
combines the through image data on which peaking processing indicating an in-focus determination portion has been performed and the clipped image data on which the peaking processing has not been performed.

13. The image processing device according to claim 12, wherein
the peaking processing is processing of performing peaking display only in a region indicating the target subject in the through image data.

14. The image processing device according to claim 9, wherein
the image clipping unit performs the clipping processing of a region other than the target subject detected by the image recognition unit.

15. The image processing device according to claim 14, wherein
the image clipping unit performs the clipping processing on one or more fixed regions on an image to display a clipped image of the one or more fixed regions, and
in a case where the image clipping unit performs the clipping processing on the target subject, a clipped image of the target subject is displayed instead of the clipped image of the fixed region close to a position of the target subject.

16. The image processing device according to claim 9, wherein
the image recognition unit performs the subject recognition processing using image data obtained by reducing a resolution of the input image data.

17. An image processing method, comprising:
by an image processing device,
setting a clipping region for a target subject detected in input image data according to an image size of a specific portion related to the target subject, and performing clipping processing.

18. A program for causing an arithmetic processing device to execute:
processing of setting a clipping region for a target subject detected in input image data according to an image size of a specific portion related to the target subject, and performing clipping processing.
